(19) United States
(12) Patent Application Publication
(10) Pub. No.: US 2026/0093345 A1
(43) Pub. Date: Apr. 2, 2026

(54) Controller Creation using Object Scanning and IR Retroreflectors

(71) Applicant: Apple Inc., Cupertino, CA (US)

(72) Inventors: Feng Zheng, San Mateo, CA (US); Chunjia Hu, San Jose, CA (US); Timo Birnschein, Redwood City, CA (US); Waleed Abdulla, Mountain View, CA (US)

(21) Appl. No.: 19/319,293

(22) Filed: Sep. 4, 2025

Related U.S. Application Data
(60) Provisional application No. 63/700,506, filed on Sep. 27, 2024.

(51) Int. Cl. G06F 3/0346; G06F 3/03; G06T 7/60; G06T 7/73; G06T 17/00

(52) U.S. Cl. CPC G06F 3/0346; G06F 3/0308; G06T 7/60; G06T 7/74; G06T 17/00; G06T 2207/10048; G06T 2207/30204

(57) ABSTRACT

A technique for creating a control from a three-dimensional object involves registering the object as a controller. Markers are placed on the object in a constellation pattern. The object is captured in image data with the markers. A geometry of the three-dimensional is determined from the image data, and a location of the markers relative to the geometry is determined. The three-dimensional object is registered as a controller by associating the geometry with the marker locations. The constellation is tracked in additional image data and motion characteristics for the controller are determined based on a determined orientation of the constellation. The orientation of the constellation is used to determine an orientation of the controller. The determined orientation of the controller is then used for a user input action.

### BACKGROUND

Some devices can generate and present Extended Reality (XR) Environments. An XR environment may include a wholly or partially simulated environment that people sense and/or interact with via an electronic system. In XR, a subset of a person's physical motions, or representations thereof, are tracked, and in response, one or more characteristics of one or more virtual objects simulated in the XR environment are adjusted in a manner that comports with realistic properties.

Handheld controllers can be used in XR environments to enhance user input. Handheld controllers can be used as input systems to interact with the virtual environment. This can enhance the immersive experience and provide a more intuitive and natural way to interact with the virtual content. These controllers can be tracked by the system to provide input, for example based on illuminators on the controller. For example, image data of the controller can be captured to determine characteristics for corresponding input.

### BRIEF DESCRIPTION OF THE DRAWINGS

FIG. 1A shows an example diagram of a user registering an object as a controller, in accordance with some embodiments.

FIG. 1B shows an example diagram of a user performing a user input action with the registered controller, in accordance with some embodiments.

FIG. 2 shows a flowchart of a technique for registering an object as a controller, in accordance with one or more embodiments.

FIG. 3 shows a flowchart of a technique for associating markers with a geometry of an object, in accordance with some embodiments.

FIG. 4 shows a flowchart of a technique for using a registered controller to perform a user input action, in accordance with some embodiments.

FIG. 5 shows a system diagram of an electronic device which can be used for controller tracking, in accordance with one or more embodiments.

FIG. 6 shows an exemplary system for use in various extended reality technologies.

### DETAILED DESCRIPTION

This disclosure pertains to systems, methods, and computer readable media to enable controller tracking in an extended reality environment. In particular, techniques described herein are directed to creating a controller using a three-dimensional object and then tracking it in an extended reality environment.

In some enhanced reality contexts, handheld controllers can be used to generate user input. These handheld controllers may be tracked to determine characteristics of the motion or pose of the controller, which can then be translated into user input. As an example, a handheld controller may include one or more markers, such as light emitting diodes (LEDs) and/or retroreflective markers, which can be tracked to determine a position and/or orientation of the controller, from which user input can be generated. Similarly, other features of the controller can be tracked in image data to determine characteristics of the movement of the controller. However, controllers are often provided for specific applications or systems. Techniques described herein provide a flexible technique for using a controller for user input by allowing a three-dimensional object to be turned into a controller.

The embodiments described herein provide a technique for registering a three-dimensional objects as a controller. Markers may be applied to the three-dimensional object in a predefined arrangement or a user-defined arrangement. According to some embodiments, the markers may be active (e.g., emitting light or other signals) or passive (e.g., reflecting light or other signals). The controller may be scanned or captured by an image capture device to generate image data, which can be used to determine a geometry of the object. For example, image data may represent the captured object from multiple angles such that a device can use this image data to construct a three-dimensional model of the object. In addition, a location of the markers on the object in relation to the 3D structure of the object can be identified. The arrangement of the markers can be identified as a constellation. The constellation can be associated with the geometry of the object, and the constellation and geometry can be stored when the object is registered as a controller such that the markers can be tracked to determine a position and/or orientation of the 3D structure of the controller.

The embodiments described herein further provide a technique for tracking an object based on markers that have been placed on the 3D object. In particular, images may be captured that include the controller in the field of view. The markers on the controller may be identified in the image data, and a controller pose may be determined based on a configuration of the markers in the image data and registration data for the controller. A user input motion can then be determined based on the controller pose, and a user input action may be triggered based on the user input motion.

Techniques described herein provide a technical improvement to input controllers by providing a technique to transform a three-dimensional object into a controller. In turn, improvements are provided for controller tracking by using a registration on a client device to map a user-generated constellation to a geometry of a controller to detect user motion.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description for purposes of explanation, numerous specific details are set forth in order to provide a thorough understanding of the disclosed concepts. As part of this description, some of this disclosure's drawings represent structures and devices in block diagram form, to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system- and business-related constraints) and that these goals may vary from one implementation to another. It will also be appreciated that such development efforts might be complex and time-consuming but would nevertheless, be a routine undertaking for those of ordinary skill in the design and implementation of graphics modeling systems having the benefit of this disclosure.

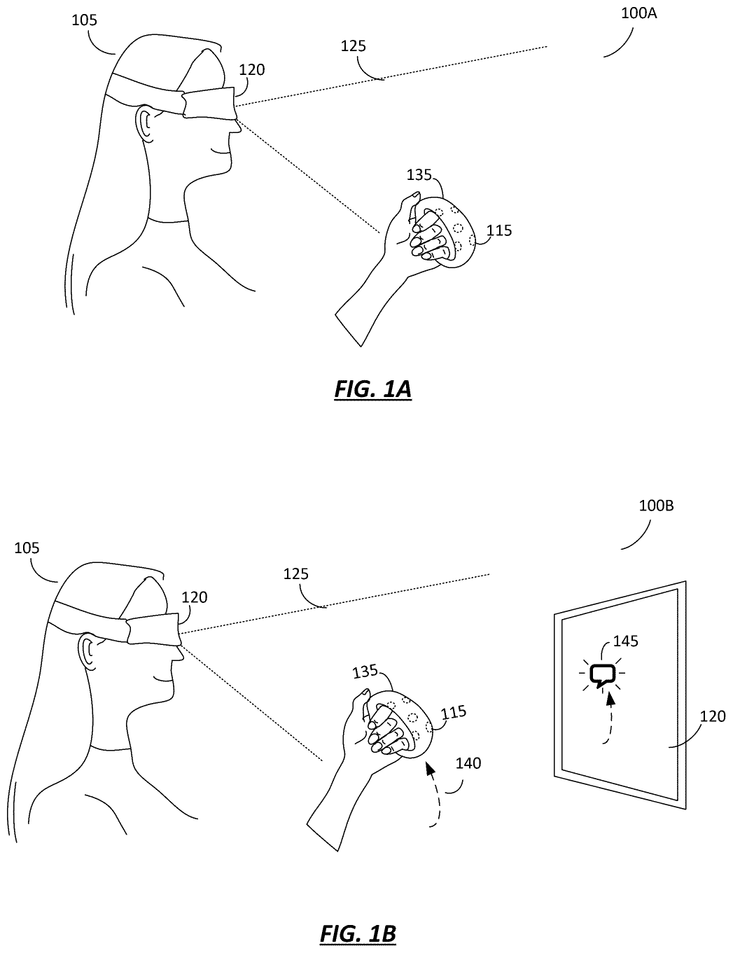

FIG. 1A is an example diagram illustrating a user 105 registering an object 135 as a controller, according to some embodiments. The diagram 100A includes a user 105 may register object 135 as a controller using electronic device 120. The object 135 may or may not be a known object to the electronic device 120. For example, the object 135 may be an arbitrary object that the user selected or created, which is registered as a controller by scanning and placing markers on the object for purposes of treating the object as a controller in a mixed reality environment. Although electronic device 120 is shown as a head-mounted device (HMD), other example devices include a smartphone, a tablet, a laptop, a desktop, a gaming console, or any other suitable device.

The plurality of markers 115 may be attached to or embedded in the 3D object 135. The object 135 may be a handheld object, such as a wand, gaming controller, a glove, a ring, a baton, or any other three-dimensional object that conforms to predefined controller parameters. In some embodiments, the markers 115 may be attached to the object 135 by a user. The arrangement of markers 115 may be initially unknown to device 105, such as during creation of object 135. According to some embodiments, the markers may be placed on the object before or after the object is scanned. Thus, the geometry may be determined before the object is scanned. Alternatively, the object may be scanned to determine the geometry and marker placement simultaneously. In some embodiments, the arrangement of the markers 115 may be guided or directed by an application or service via a computing device, such as electronic device 120. Alternatively, the user 105 may be prompted by the electronic device 120 to attach the markers 115 to the object 135 in accordance with one or more predefined marker placement parameters. The plurality of markers 105 may be active (e.g., emitting light or other signals) or passive (e.g., reflecting light or other signals). For example, the plurality of markers 105 may be infrared (IR) illuminators or IR reflectors that can be detected by an IR camera. The plurality of markers 115 may have different shapes, sizes, colors, or patterns to facilitate their identification and differentiation.

According to some embodiment, a marker can be placed on a movable button or other component on the object that, when depressed or otherwise manipulated, can cause the marker on the button to move relative to the other markers. That is, the configuration of the markers may not always be consistent. According to one or more embodiments, the button press can be detected based on the changed relationship among the markers. Accordingly, the registration of the object as a controller may additionally include determining a coordinate system for the movement, for example in a controller space, which may indicate movement of the button separately from movement of the controller as a whole.

The electronic device 120 may include one or more cameras which can be used to capture image data from which the object 135 can be captured. For example, the user 105 may place the object in the field of view 125 of the camera of the electronic device 120. In some embodiments, the electronic device 120 may prompt the user to capture images of the object 135 from multiple angles such that a geometry of the object can be reconstructed. In addition, the image data may be used to determine location information for the markers with respect to the geometry of the object. Example cameras include depth cameras, infrared cameras, visible light cameras, or the like.

The object 135 may be registered as a controller by storing an association between the geometry of the object 135 with the constellation of the markers 115. In some embodiments, registration of the controller may additionally include determining an input portion of the object and associating the input portion with the geometry and the constellation.

Turning to FIG. 1B, an example diagram is presented in which the object 135 is used as a handheld controller to perform a user input action. In particular, the markers 115 may be detected by image data captured by the electronic device 120. A motion of the markers 115 can be used to determine a corresponding motion of the object 135 based on controller registration data for the object 135. The object 135 may be used for providing user input for one or more applications. Example relevant applications include a gaming application, a virtual reality application, an augmented reality application, or other application that utilize a handheld controller as an input device. In the example shown, the motion of the controller 135 is used to drag an icon 145 on a virtual display 120 in an extended reality environment, for example using augmented reality, virtual reality, enhanced reality, or the like.

According to one or more embodiments, because the geometry of the controller is known, a virtual representation of the controller can be generated. In addition, the virtual representation can be accurately positioned based on the tracking of the marker locations. As an example, if the physical object is a paintbrush that the user is using to create digital art, a virtual representation of the paintbrush performing the strokes can be generated and presented accurately in a mixed reality environment, either to a local user, or to another user in a common mixed reality communication session.

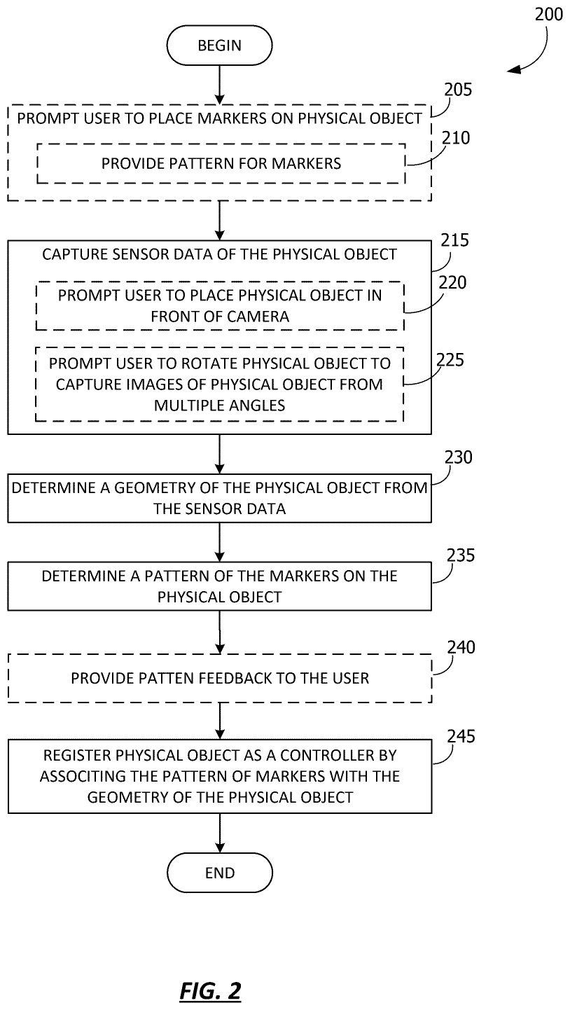

FIG. 2 shows a flowchart of a technique for registering an object as a controller, in accordance with one or more embodiments. In particular, FIG. 2 shows a technique for mapping a constellation of markers to a geometry of an object for controller registration during a registration or enrollment phase, in accordance with one or more embodiment. Although the flowchart describes various components as performing particular processes, it should be understood that the flow of the diagram may be different in accordance with some embodiments, and the functionality of the components may be different in accordance with some embodiments. Further, the various process may be performed in a different order.

The flowchart 200 begins at block 205, where the system optionally prompts a user to place markers on the physical object according to the pattern. The physical object may be any suitable object that a user wishes to use as a controller, such as a pen, a toy, a tool, or the like. The user may attach the markers to the physical object using adhesive, magnets, or any other suitable means. In some embodiments, the system may provide a set of parameters for marker placement. For example, at least three markers may need to be placed on the object, or the markers should not be placed all in a row. Thus, the user may choose the arrangement of the markers within marker parameters. In some embodiments, the marker parameters may be predefined. In some embodiments, the marker parameters may be specific to the device type, or an application for which the object is being registered as a controller. The markers may be IR retroreflectors, which are devices that reflect IR light back to its source.

Optionally, as shown at block 210, the system may provide a pattern for markers to be placed on a physical object. For example, a predefined pattern may be provided by the system for placement of the objects on the physical object. The pattern may specify the number, shape, size, and arrangement of the markers on the physical object. The pattern may be designed to facilitate the detection and tracking of the markers by the camera 505. The pattern may be displayed on the display 580, or transmitted to another device, such as a printer, a projector, or a mobile device.

The flowchart 200 proceeds to block 215, where sensor data is captured of the physical object. The sensor data may include image data captured by a camera of the device. In some embodiments, additional sensor data may be captured by sensors of the local device and/or the controller, such as accelerometer data, gyroscope data, magnetometer data, or the like. The sensor data may facilitate localization of the object being registered as a controller. That is, a position and/or orientation of the local device capturing the images of the physical object may be used to determine relative characteristics and position information for the object.

Optionally, as shown at block 220, the system may prompt the user to place the physical object in front of the camera. The camera may be a stereo camera, a depth camera, an IR camera, or any other suitable camera that can capture image data of the physical object and the markers. The camera may be integrated within the device performing the registration or may be communicably coupled to the device, for example via a wired or wireless connection. In addition, at optional block 225, the system may prompt the user to rotate the physical object to capture images or other sensor data of the physical object from multiple angles. The system may use the sensor data to determine the rotation angle of the physical object.

The flowchart 200 proceeds to block 230, where the systems determines a geometry of the physical object from the sensor data. The geometry may include a three-dimensional (3D) model, a mesh, a point cloud, a contour, or other representation of the physical object. The geometry of the object may be reconstructed from the sensor data using a variety of techniques, such as 3D scanning, depth determination and combination from multiple frames, trained networks, or the like.

At block 235, the flowchart 200 includes determining a pattern of the markers on the physical object, such as a constellation. The pattern may include characteristics of the 3D positions, orientations, and shapes of the markers on the physical object. In some embodiments, the images of the object may be analyzed to detect the markers. The pattern of the markers may be determined based on the image data and/or additional data such as depth data, brightness, or the like. In some embodiments, the markers may be identified in the multiple images captured of the physical object, for example as described at block 225, to triangulate the 3D positions of the markers.

Optionally, as shown at bock 240, the system may generate and present feedback to the user regarding the marker arrangement. For example, the arrangement of the markers placed on the object can be cross-referenced against a set of parameters, such as specifications or rules that define minimum requirements for the device to track the object. As an example, a set of a parameters may include a predefined number of markers visible at all times. In this case, if after the scan it is determined that the marker placement fails to satisfy the placement parameters, then the user may be prompted to place additional markers on the device such that the placement parameters are satisfied.

The flowchart 200 concludes at block 245, where the system registers the physical object as a controller by associating the pattern of the markers with the geometry of the physical object. In particular, the system may store controller information such that the object can be identified as a controller. Further, the system may store controller information used for tracking, such as a geometry of the object registered as a controller, as well as the marker constellation such that the constellation can be used to track the object being used as a controller during runtime.

According to one or mor embodiments, registering the physical object as a controller may include determining a spatial relationship between the structural features of the physical object and the markers. As an example, the device can determine that the structure has a particular orientation when a particular orientation of the constellation is visible. In some embodiments, the registration may track particular portions of the structure which are relevant for determining orientation of the object. As an example, the object may have deformable portions. Returning to the paintbrush example, if the paintbrush has a tip that has a marker, the tip may deform upon making contact with a surface. In this case, the deformation can be tracked based on the motion of the tip marker relative to other markers on the object. Accordingly, a virtual representation of the paintbrush can be modified accordingly by tracking the movement of the marker.

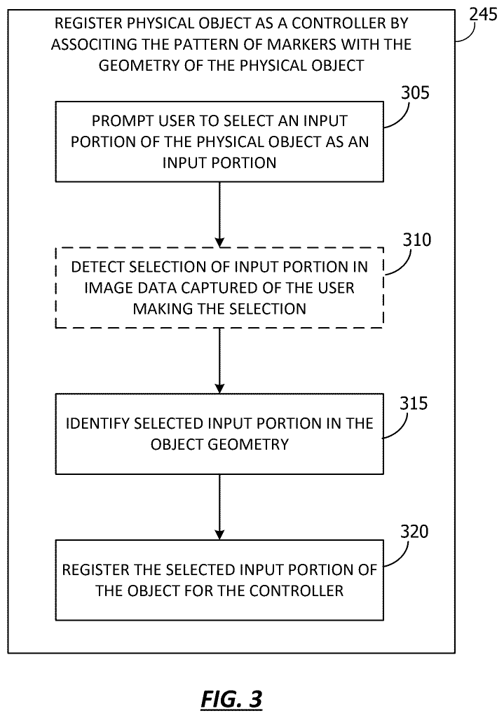

FIG. 3 shows a flowchart of a technique for associating markers with a geometry of an object, in accordance with some embodiments. In particular, FIG. 3 shows an example technique for registering the physical object as a controller, as described above with respect to block 240 of FIG. 2. Although the flowchart describes various components as performing particular processes, it should be understood that the flow of the diagram may be different in accordance with some embodiments, and the functionality of the components may be different in accordance with some embodiments. Further, the various process may be performed in a different order.

At block 305, the system may prompt the user to select an input portion of the physical object as an input portion for the controller. The input portion may be the specific portion of the geometry of the object which is translated to a user input motion. The input portion may be any part of the physical object that the user wishes to use to convert into user input, such as a tip, a nub, a joint, or the like.

Optionally, as shown at block 310, the system may detect a selection of an input portion of the object in image data captured of the user making the selection. For example, the selection may occur by a user touching the input portion with their finger, a stylus, a pointer, or the like. The system may recognize the touch using a vision-based touch detection process based on captured image data. For example, a gap distance between the touching object and the physical object may be determined and analyzed to detect a touch event.

At block 315, the system may identify the selected input portion in the object geometry. That is, the touch location can be identified in the 3D model or other geometry information for the physical object. For example, the system may determine a 3D position and orientation of the selection input portion to locate the input portion of the physical object selected by the user. In some embodiments, the system may additionally or alternatively use the geometry of the physical object and/or the marker constellation of to refine the identification of the selected input portion.

The flowchart concludes at block 320, where the system registers the selected input portion of the object for the controller. For example, the portion of the geometry of the physical object associated with the selected input portion may be stored with the controller registration for use during runtime.

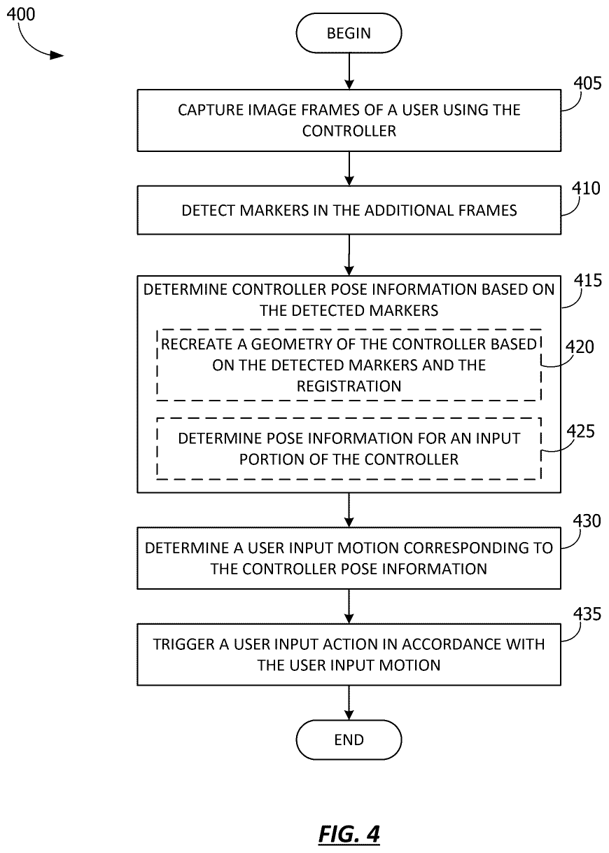

FIG. 4 shows a flowchart of a technique for using an object registered as a controller to perform a user input action, in accordance with some embodiments. Although the flowchart describes various components as performing particular processes, it should be understood that the flow of the diagram may be different in accordance with some embodiments, and the functionality of the components may be different in accordance with some embodiments. Further, the various process may be performed in a different order.

The flowchart 400 begins at block 405, where the system captures image frames of a user using the controller. The system may capture the images during a runtime stage. For example, the image frames may be captured as the user is using an application that utilizes the controller for user input. At block 410, the system may detect markers in the image frames. The system may use various techniques, such as computer vision, machine learning, image processing, or the like, to detect the markers in the image frames, and to determine their position and/or orientations.

The flowchart 400 proceeds to block 415, where the system determines controller pose information based on the detected markers. The controller pose information may include the 3D position and/or orientation of the markers, from which a position and/or orientation of the physical object can be determined based on the known spatial relationship between the markers and the 3D structure of the controller. In some embodiments, the system may use the controller registration to associate the detected markers with the geometry of the physical object.

The system may translate the motion of the physical object to a user input motion using various techniques. For example, as shown at optional block 420, the system may recreate a geometry of the controller based on the detected markers and the registration. That is, the system may use the controller registration to retrieve the geometry of the physical object, and to transform the marker locations to the geometry according to the controller pose information. In addition, at optional block 425, the system may determine pose information for an input portion of the controller. As described above, the registration may maintain a mapping between the controller and an input portion of the controller. The system may use the controller registration to determine its 3D position and orientation of the input portion based on the controller pose information.

The flowchart 400 proceeds to block 430, where the system may determine a user input motion corresponding to the controller pose information. The user input motion may be a motion or a pose of the physical object or the selected input portion which represents the user intent for user input.

The flowchart concludes at block 435, where the system triggers a user input action in accordance with the user input motion. The system may use the user input motion to trigger a user input action for a current application or other process based on the user input motion. For example, returning to FIG. 1, a user motion of swiping the controller may result in a dragging motion of an icon on a virtual display.

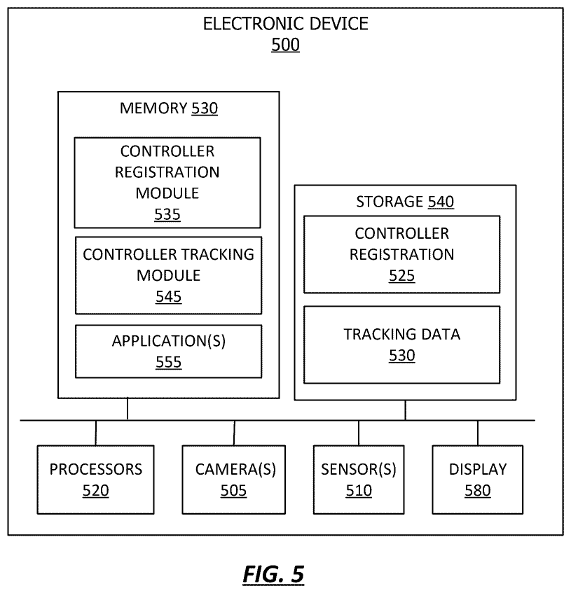

Referring to FIG. 5, a simplified system diagram is depicted. In particular, the system includes electronic device 500 used to register and trac a physical object as a controller. Electronic device 500 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 500 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. According to one or more embodiments, electronic device 500 is utilized to interact with a user interface of an application. It should be understood that the various components and functionality within electronic device 500 may be differently distributed across the modules or components, or even across additional devices.

Electronic device 500 may include one or more processors 520, such as a central processing unit (CPU) or graphics processing unit (GPU). Electronic device 500 may also include a memory 530. Memory 530 may include one or more different types of memory, which may be used for performing device functions in conjunction with processor(s) 520. For example, memory 530 may include cache, ROM, RAM, or any kind of transitory or non-transitory computer-readable storage medium capable of storing computer-readable code. Memory 530 may store various programming modules for execution by processor(s) 520, including controller registration module 535, controller tracking module 545, and one or more application(s) 555.

Controller registration module 535 may be used to register a physical object for use as a controller. The controller registration module may determine a geometry of the physical object and tie the geometry to a constellation of markers on the physical object. In some embodiments, controller registration module 535 additionally register an input portion of the physical object. Controller tracking module 545 may analyze image data, for example captured by camera(s) 505 to determine position and/or orientation information for the physical controller, or the markers on the physical controller. The position and/or orientation information may then be used for user input, for example for application(s) 555.

Electronic device 500 may also include storage 540. Storage 540 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 640 may be utilized to store various data and structures which may be utilized for storing data related to controller tracking. In addition, storage 540 may be configured to store the controller registration data 525, such as the mapping between the geometry and the markers. Similarly, controller registration 525 may also map the input portion of the object to the geometry of the object and/or the markers for the object. Storage 540 may also include tracking data 530 which may be used for performing tracking, such as trained networks, controller data, user preferences, and the like

In one or more embodiments, each of the one or more cameras 505 may be a traditional RGB camera or a depth camera. Further, cameras 505 may include a stereo camera or other multicamera system. In addition, electronic device 500 may include other sensors which may collect sensor data for tracking user movements, such as a depth camera, infrared sensors, or orientation sensors, such as one or more gyroscopes, accelerometers, and the like.

Electronic device 500 may also include a display 580 which may present a UI for interaction by a user. Display 580 may be an opaque display or may be semitransparent or transparent. Display 580 may incorporate LEDs, OLEDs, a digital light projector, liquid crystal on silicon, or the like.

Although electronic device 500 is depicted as comprising the numerous components described above, in one or more embodiments, the various components may be distributed across multiple devices. Accordingly, although certain calls and transmissions are described herein with respect to the particular systems as depicted in one or more embodiments, the various calls and transmissions may be made differently directed based on the differently distributed functionality. Further, additional components may be used, some combination of the functionality of any of the components may be combined.

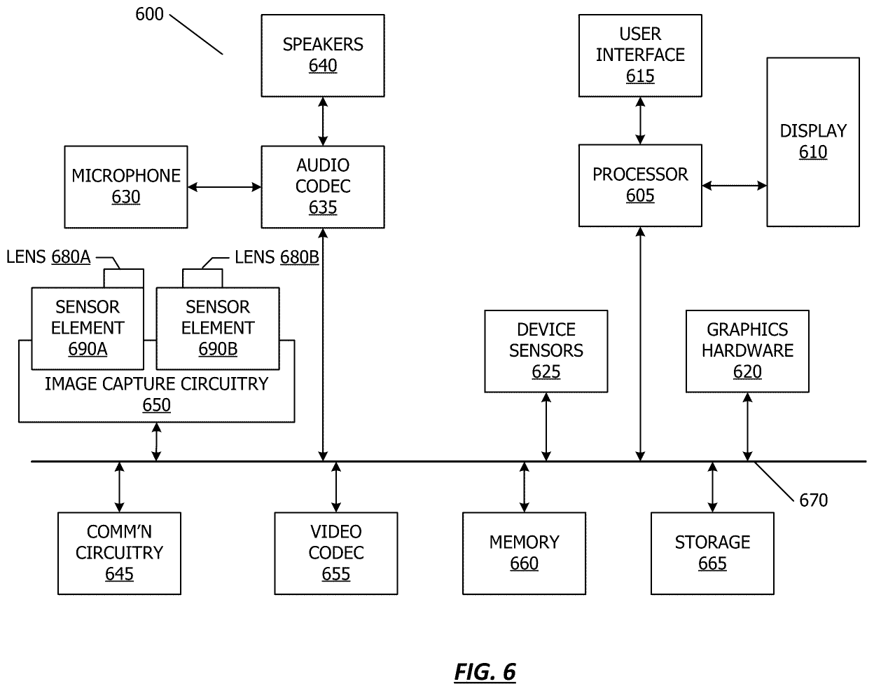

Referring now to FIG. 6, a simplified functional block diagram of illustrative multifunction electronic device 600 is shown according to one embodiment. Each of electronic devices may be a multifunctional electronic device or may have some or all of the described components of a multifunctional electronic device described herein. Multifunction electronic device 600 may include processor 605, display 610, user interface 615, graphics hardware 620, device sensors 625 (e.g., proximity sensor/ambient light sensor, accelerometer and/or gyroscope), microphone 630, audio codec(s) 635, speaker(s) 640, communications circuitry 645, digital image capture circuitry 650 (e.g., including camera system), video codec(s) 655 (e.g., in support of digital image capture unit), memory 660, storage device 665, and communications bus 670. Multifunction electronic device 600 may be, for example, a digital camera or a personal electronic device such as a personal digital assistant (PDA), personal music player, mobile telephone, or a tablet computer.

Processor 605 may execute instructions necessary to carry out or control the operation of many functions performed by device 600 (e.g., such as the generation and/or processing of images as disclosed herein). Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen, touch screen, gaze, and/or gestures. Processor 605 may also, for example, be a system-on-chip such as those found in mobile devices and include a dedicated GPU. Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include two (or more) lens assemblies 680A and 680B, where each lens assembly may have a separate focal length. For example, lens assembly 680A may have a short focal length relative to the focal length of lens assembly 680B. Each lens assembly may have a separate associated sensor element 690A and sensor element 690B. Alternatively, two or more lens assemblies may share a common sensor element. Image capture circuitry 650 may capture still and/or video images. Output from image capture circuitry 650 may be processed by video codec(s) 655 and/or processor 605 and/or graphics hardware 620, and/or a dedicated image processing unit or pipeline incorporated within circuitry 650. Images so captured may be stored in memory 660 and/or storage 665.

Image capture circuitry 650 may capture still, and video images that may be processed in accordance with this disclosure, at least in part, by video codec(s) 655 and/or processor 605 and/or graphics hardware 620, and/or a dedicated image processing unit incorporated within circuitry 650. Images so captured may be stored in memory 660 and/or storage 665. Memory 660 may include one or more different types of media used by processor 605 and graphics hardware 620 to perform device functions. For example, memory 660 may include memory cache, read-only memory (ROM), and/or random-access memory (RAM). Storage 665 may store media (e.g., audio, image and video files), computer program instructions or software, preference information, device profile information, and any other suitable data. Storage 665 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 660 and storage 665 may be used to tangibly retain computer program instructions, or code organized into one or more modules and written in any desired computer programming language. When executed by, for example, processor 605 such computer program code may implement one or more of the methods described herein.

Various processes defined herein consider the option of obtaining and utilizing a user's identifying information. For example, such personal information may be utilized in order to track motion performed by the user using the controller. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-4, or the arrangement of elements shown in FIGS. 1 and 5-6 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
capturing image data of a three-dimensional object;
identifying a constellation of markers on the three-dimensional object in the image data;
defining a spatial relationship between the constellation and a geometry of the three-dimensional object;
capturing image data of the constellation;
determining an orientation of the constellation from the image data of the constellation; and
determining an orientation of the three-dimensional object based on the orientation of the constellation and the spatial relationship.

2. The method of claim 1, further comprising:
generating a three-dimensional digital reconstruction of the three-dimensional object based on the orientation of the constellation.

3. The method of claim 1, further comprising:
registering an input portion of the three-dimensional object in accordance with the constellation.

4. The method of claim 3, wherein identifying the constellation of markers comprises:
prompting a user to touch the markers; and
in response to the prompt, detecting a touch between a finger and the three-dimensional object.

5. The method of claim 4, further comprising:
determining a location characteristic of the input portion of the three-dimensional object based on the touch and the registration; and
performing a user input action based on the location characteristic of the input portion of the three-dimensional object.

6. The method of claim 1, wherein the constellation of markers comprises at least one selected from a group consisting of an IR illuminator and an IR reflector.

7. The method of claim 1, wherein defining the spatial relationship between the constellation and the geometry of the three-dimensional object comprises:
registering three-dimensional object as a controller by associating the constellation with the geometry of the three-dimensional object.

8. A non-transitory computer readable medium comprising computer readable code executable by one or more processors to:
capture image data of a three-dimensional object;
identify a constellation of markers on the three-dimensional object in the image data;
define a spatial relationship between the constellation and a geometry of the three-dimensional object;
capture image data of the constellation;
determine an orientation of the constellation from the image data of the constellation; and
determine an orientation of the three-dimensional object based on the orientation of the constellation and the spatial relationship.

9. The non-transitory computer readable medium of claim 8, further comprising computer readable code to:
generating a three-dimensional digital reconstruction of the three-dimensional object based on the orientation of the constellation.

10. The non-transitory computer readable medium of claim 9, further comprising computer readable code to:
register an input portion of the three-dimensional object in accordance with the constellation.

11. The non-transitory computer readable medium of claim 10, wherein the computer readable code to identify the constellation of markers comprises computer readable code to:
prompt a user to touch the markers; and
in response to the prompt, detect a touch between a finger and the three-dimensional object.

12. The non-transitory computer readable medium of claim 11, further comprising computer readable code to:
determine a location characteristic of an input portion of the three-dimensional object based on the touch and the registration; and
perform a user input action based on the location characteristic of the input portion of the three-dimensional object.

13. The non-transitory computer readable medium of claim 8, wherein the constellation of markers comprises at least one selected from a group consisting of an IR illuminator and an IR reflector.

14. The non-transitory computer readable medium of claim 8, wherein the image data comprises a plurality of images capturing the three-dimensional object from different views.

15. A system comprising:
one or more processors; and
one or more computer readable media comprising the computer readable code executable by one or more processors to:
capture image data of a three-dimensional object;
identify a constellation of markers on the three-dimensional object in the image data;
define a spatial relationship between the constellation and a geometry of the three-dimensional object;
capture image data of the constellation;
determine an orientation of the constellation from the image data of the constellation; and
determine an orientation of the three-dimensional object based on the orientation of the constellation and the spatial relationship.

16. The system of claim 15, further comprising computer readable code to:
generate a three-dimensional digital reconstruction of the three-dimensional object based on the orientation of the constellation.

17. The system of claim 15, further comprising computer readable code to:
register an input portion of the three-dimensional object in accordance with the constellation.

18. The system of claim 15, wherein the constellation of markers comprises at least one selected from a group consisting of an IR illuminator and an IR reflector.

19. The system of claim 15, wherein the image data comprises a plurality of images capturing the three-dimensional object from different views.

20. The system of claim 15, wherein the computer readable code to define the spatial relationship between the constellation and the geometry of the three-dimensional object comprises computer readable code to:
register three-dimensional object as a controller by associating the constellation with the geometry of the three-dimensional object.
